(19) United States
(12) Patent Application Publication
(10) Pub. No.: US 2015/0277945 A1
(43) Pub. Date: Oct. 1, 2015

(54) VIRTUAL COMPUTER SYSTEM

(71) Applicants: Dai MIYAUCHI, (US); Takayuki ITO, (US)

(72) Inventors: Dai Miyauchi, Tokyo (JP); Takayuki Ito, Tokyo (JP)

(73) Assignee: Mitsubishi Electric Corporation, Chiyoda-ku, Tokyo (JP)

(21) Appl. No.: 14/435,270

(22) PCT Filed: Nov. 15, 2012
(86) PCT No.: PCT/JP2012/079663

§ 371 Date: Apr. 13, 2015

(51) Int. Cl. G06F 9/455

(52) U.S. Cl. CPC G06F 9/45545; G06F 9/45558; G06F 2009/45591

(57) ABSTRACT

A front-end driver A 121 receives control data for an I/O device A 401 and outputs the data to a standard driver call function (1) 13. A front-end driver B 122 receives control data for an I/O device B 402 and outputs the data to a standard driver call function (1) 13. The standard driver call function (1) 13 receives the control data for the I/O device A 401 and the control data for the I/O device B 402, and outputs the data to a standard driver call function (2) 31. The standard driver call function (2) 31 outputs the control data for the I/O device A 401 to a standard device driver A 321, and the control data for the I/O device B 402 to the standard device driver B 322. The standard device driver A 321 controls the I/O device A 401 based on the control data, and a standard device driver B 322 controls the I/O device B 402 based on the control data.

### TECHNICAL FIELD

The present invention relates to a virtual computer system.

### BACKGROUND ART

With respect to a virtualization method of a conventional 110 (Input/Output) device, virtualization is implemented by methods of full virtualization or paravirtualization (for instance, Patent Literature 1 and Patent Literature 2).

The I/O device is virtualized, and thereby a benefit to be able to update the system can be obtained without changing an environment of a guest OS (Operating System) at the time of updating the hardware (H/W).

The full virtualization is a method to fully emulate an existing physical I/O device by a host OS and to allow the guest OS to use the emulated I/O device. From the guest OS, the emulated I/O device is controlled by a standard device driver mounted on the guest OS; the emulated I/O device controls the physical I/O device using a standard device driver mounted on the host OS.

The paravirtualization is a method to install a device driver which takes an interface with a virtualization software (virtual machine monitor) to both the guest OS and the host OS.

The device driver of the guest OS side is referred to as a front-end driver, and the device driver of the host OS side is referred to as a back-end driver.

The control method of the physical I/O device from the guest OS is as follows: First, the control data of the device is passed from the front-end driver to the back-end driver using an internal communication function of the virtualization software and a shared memory.

The back-end driver converts the control data of the device passed from the front-end driver to data having a structure which can be used by the standard device driver mounted on the host OS, and controls the physical I/O device, via the standard device driver on the host OS using the converted control data.

### CITATION LIST

### Patent Literature

Patent Literature 1: JP 2010-205124A

Patent Literature 2: JP 2009-134601A

### SUMMARY OF INVENTION

### Technical Problem

There is a problem in the conventional virtualization of the I/O device including full virtualization or paravirtualization that an internal configuration of a virtualization software has to be developed for each physical I/O device which is a target of the virtualization.

In the conventional full virtualization, a function to fully emulate the physical I/O device has to be developed; such a development has to be done after understanding the details of the internal configuration of the virtualization software and the physical I/O device.

Therefore, there is a problem that a complicated emulation function has to be developed for each physical I/O device which is a target of the virtualization.

Further, in the conventional paravirtualization, a pair of a front-end driver and a back-end driver has to be developed for each physical I/O device which is a target of the virtualization.

This is because the control data passed to the back-end driver from the front-end driver via the internal communication function of the virtualization software has to be converted to data having a structure which can be used by the back-end driver on the standard device driver.

Therefore, a pair of the front-end driver and the back-end driver specialized for the I/O device of the target has to be developed.

That is, similarly to the full virtualization, there is a problem that the front-end driver and the back-end driver have to be developed for each physical I/O device which is a target of the virtualization after understanding the details of the internal configuration of the virtualization software.

The present invention aims to solve the above problems; a main object of the invention is to eliminate the development of the back-end driver for each physical I/O device and to realize a configuration which enables to update the system without changing the environment of the guest OS side.

### Solution to Problem

According to the present invention, a virtual computer system includes:

hardware including a physical processor, a physical memory, and a plurality of physical I/O (Input/Output) devices;

a host OS (Operating System) and a virtual machine monitor that operate on the hardware; and

a guest OS that operates on the virtual machine monitor,

wherein the virtual machine monitor relays data between the guest OS and the host OS,

wherein the guest OS includes:

a plurality of front-end drivers, each of which corresponds to a physical I/O device of the plurality of physical I/O devices, and receives control data for controlling the corresponding physical I/O device; and

a guest OS side administration unit that receives the control data from each front-end driver and outputs the received control data to the virtual machine monitor,

wherein the host OS includes:

a plurality of standard device drivers, each of which corresponds to a physical I/O device of the plurality of physical I/O devices, receives the control data from the related front-end driver that shares the corresponding physical I/O device, and controls the corresponding physical I/O device based on the received control data; and

a host OS side administration unit that receives the control data output from the guest OS side administration unit from the virtual machine monitor, and outputs the received control data to the standard device driver related to the front-end driver which is an output source of the received control data.

### Advantageous Effects of Invention

In the present invention, a guest OS side administration unit receives control data from a plurality of front-end drivers, and outputs the control data from the plurality of front-end drivers to the virtual machine monitor; the host OS side administration unit receives from the virtual machine monitor the control data from the plurality of front-end drivers, and outputs each control data to the corresponding device driver.

Therefore, according to the present invention, there is no need to develop the back-end driver for each physical I/O device, and further the system can be updated without changing the environment of the guest OS side at the time of updating the H/W.

### BRIEF DESCRIPTION OF DRAWINGS

FIG. 1 is a diagram illustrating a configuration example of a virtual computer system according to a first embodiment.

FIG. 2 is a diagram explaining a problem which may occur at the time of passing/receiving control data.

FIG. 3 is a diagram explaining a method of passing/receiving the control data according to the first embodiment.

FIG. 4 is a flowchart illustrating an application process according to the first embodiment.

FIG. 5 is a flowchart illustrating a front-end driver process according to the first embodiment.

FIG. 6 is a flowchart illustrating a mapping process (1) of a standard driver call function (1) according to the first embodiment.

FIG. 7 is a flowchart illustrating a mapping process (2) of the standard driver call function (2) according to the first embodiment.

FIG. 8 is a flowchart illustrating a process of the standard driver call function (1) according to the first embodiment.

FIG. 9 is a flowchart illustrating a process of the standard driver call function (2) according to the first embodiment.

FIG. 10 is a diagram illustrating a hardware configuration example of a virtual computer system according to the first embodiment.

### DESCRIPTION OF EMBODIMENTS

### Embodiment 1

The present embodiment will explain a configuration, which eliminates the development with understanding the internal configuration of the virtualization software for each physical I/O device, and receives the benefit of the virtualization of updating the system without changing environment of a guest OS side at the time of H/W update.

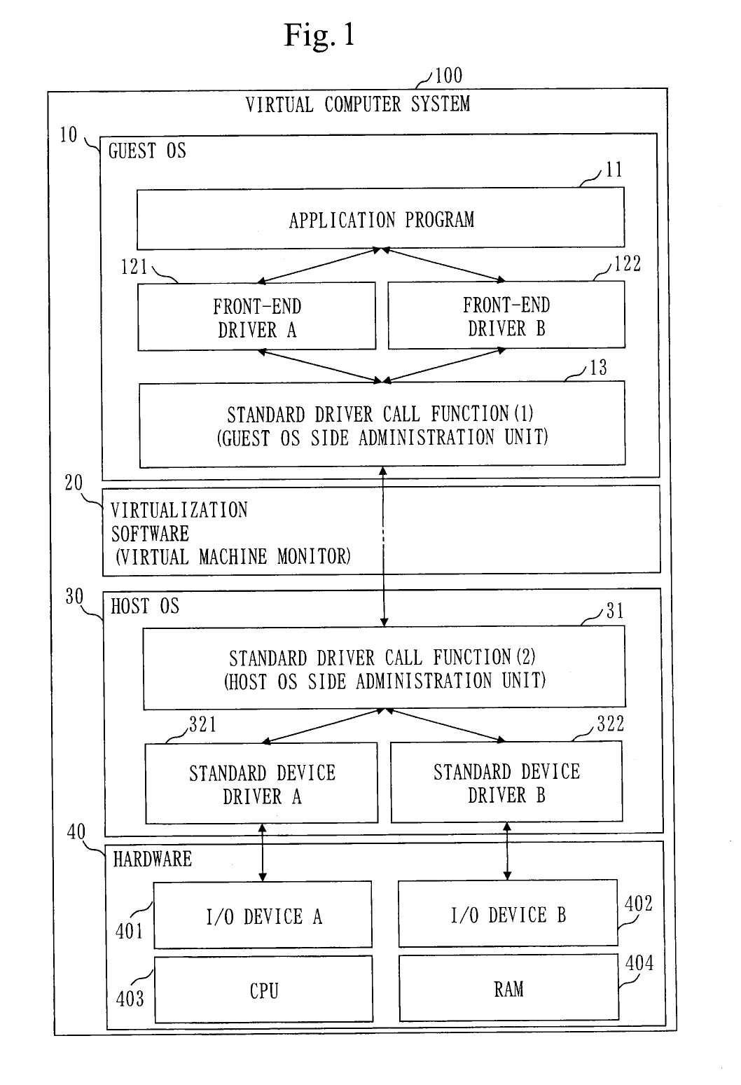

FIG. 1 is a diagram illustrating a configuration example of a virtual computer system 100 according to a first embodiment.

The virtual computer system 100 is provided with hardware 40; a host OS 30 and a virtualization software 20 operate using the hardware 40.

Then, the guest OS 10 operates using the virtualization software 20.

The virtualization software 20 is also referred to as a virtual machine monitor.

The virtualization software 20 relays data between the guest OS 10 and the host OS 30.

Here, there are types of virtualization software 20: a host OS type in which the virtualization software 20 operates as the application program on the host OS 30; and a hyper-visor type in which the virtualization software 20 itself operates as the host OS 30.

The hardware 40 is provided with an I/O device A 401, an I/O device B 402, a CPU (Central Processing Unit) 403, and a RAM (Random Access Memory) 404.

The I/O device A 401 and the I/O device B 402 are, for instance, a secondary memory device such as a magnetic disk drive, a communication board, and the like.

Here, FIG. 1 illustrates only two I/O devices of the I/O device A 401 and the I/O device B 402; however, the number of the I/O devices is not limited to two.

Further, the hardware 40 of the virtual computer system 100 may include devices other than ones shown in FIG. 1.

The guest OS 10 includes a front-end driver A 121 and a front-end driver B 122 as device drivers for the exclusive use of the virtualization software 20.

The front-end driver A 121 corresponds to the I/O device A 401, and the front-end driver B 122 corresponds to the I/O device B 402.

Further, the guest OS 10 includes a standard driver call function (1) 13 which is shared by the I/O devices being a target of the virtualization.

The standard driver call function (1) 13 is a function that interfaces with the virtualization software 20 at the guest OS 10 side, receiving control data for all the I/O devices and outputting the control data for all the I/O devices to the virtualization software 20.

The standard driver call function (1) 13 corresponds to a guest OS side administration unit.

Further, the guest OS 10 includes an application program 11.

The application program 11 issues control data to control the I/O device A 401 or the I/O device B 402.

The host OS 30 includes a standard device driver A 321 of the I/O device A 401 and a standard device driver B 322 of the I/O device B 402.

Further, the host OS 30 includes a standard driver call function (2) 13 which is shared by the I/O devices being a target of the virtualization.

The standard driver call function (2) 31 is a function that interfaces with the virtualization software 20 at the host OS 30 side, receiving the control data for all the I/O devices from the virtualization software 20.

The standard driver call function (2) 31 corresponds to a host OS side administration unit.

Passing/receiving of the control data between the guest OS 10 and the host OS 30 is performed by the standard driver call function (1) 13 and the standard driver call function (2) 31, hiding the virtualization software 20 from the front-end driver A 121, the front-end driver B 122, the standard device driver A 321, and the standard device driver B 322.

Passing/receiving of the control data between the standard driver call function (1) 13 and the standard driver call function (2) 31 is performed using the internal communication function of the virtualization software 20.

Next, the operation will be explained.

The I/O device A 401 is controlled by cooperation of the front-end driver A 121, the standard driver call function (1) 13, the standard driver call function (2) 31, and the standard device driver A 321.

In the same manner, the I/O device B 402 is controlled by cooperation of the front-end driver B 122, the standard driver call function (1) 13, the standard driver call function (2) 31, and the standard device driver B 322.

First, from the application program 11, the control data for controlling the I/O device A 401 and the I/O device B 402 are passed to the front-end driver A 121 and the front-end driver B 122, respectively.

At this time, in the I/O device control process by the application program 11, in order not to let the application program 11 be aware of the virtualization, the interface of the control data from the application program 11 to be passed to the front-end driver A 121 and the front-end driver B 122 are the same as the interface of the standard device driver A 321 and the standard device driver B 322.

Next, the control data is passed from the front-end driver A 121 and the front-end driver B 122 to the standard driver call function (1) 13.

At this time, in order not to let the front-end driver A 121 and the front-end driver B 122 be aware of the internal configuration of the virtualization software 20, the interface of the control data to be passed to the standard driver call function (1) 13 from the front-end driver A 121 and the front-end driver B 122 are the same as the interface of the standard device driver A 321 and the standard device driver B 322.

Subsequently, the standard driver call function (1) 13 outputs the control data to the virtualization software 20.

The virtualization software 20 outputs the control data to the standard driver call function (2) 31.

The standard driver call function (2) 31 passes the received control data to the corresponding standard device driver A 321 and the corresponding standard device driver B 322.

The standard device driver A 321 and the standard device driver B 322 respectively control the I/O device A 401 and the I/O device B 402 based on the received control data.

At this time, the control data received by the standard device driver A 321 and the standard device driver B 322 are normal control data that is not specialized for the virtualization, and thus it is unnecessary to change the standard device driver A 321 and the standard device driver B 322 for the virtualization.

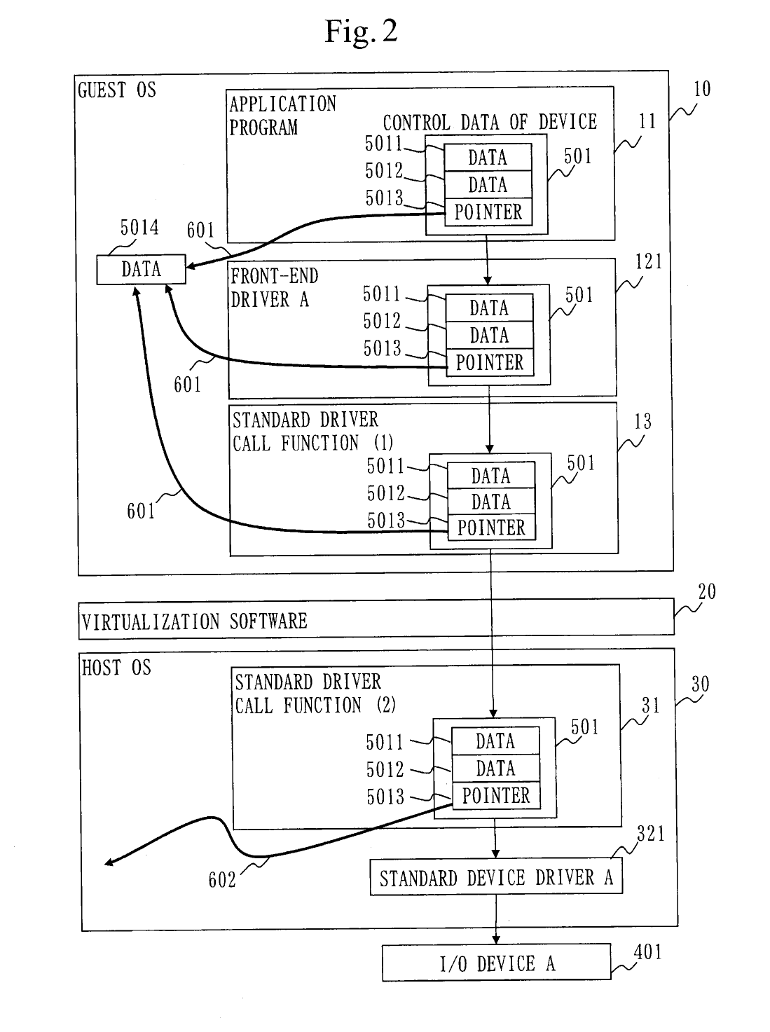

FIG. 2 illustrates details of passing/receiving of the data.

In the following, a case will be explained, in which the control data for the I/O device A 401 is issued from the application program 11 to the front-end driver A 121.

Control data 501 of the I/O device sometimes, in general, includes a pointer 5013, which may cause the following problems:

Since the control data 501 of the I/O device is data on the guest OS 10, a pointer 5013 references data 5014 of a logical address 5014 assigned to the guest OS 10 (referred to as a “guest OS address”, hereinafter) (601).

When the control data 501 is passed to the front-end driver A 121 and the standard driver call function (1) 13 on the guest OS 10, the data 5014 can be referenced without any problem; however, when the control data 501 is passed to the standard driver call function (2) 31 on the host OS 30, since the pointer 5013 indicates the guest OS address, the data cannot be referenced correctly (602).

With this situation, even if the control data is passed to the standard device driver A 321, the standard device driver A 321 cannot control the I/O device A 401 correctly.

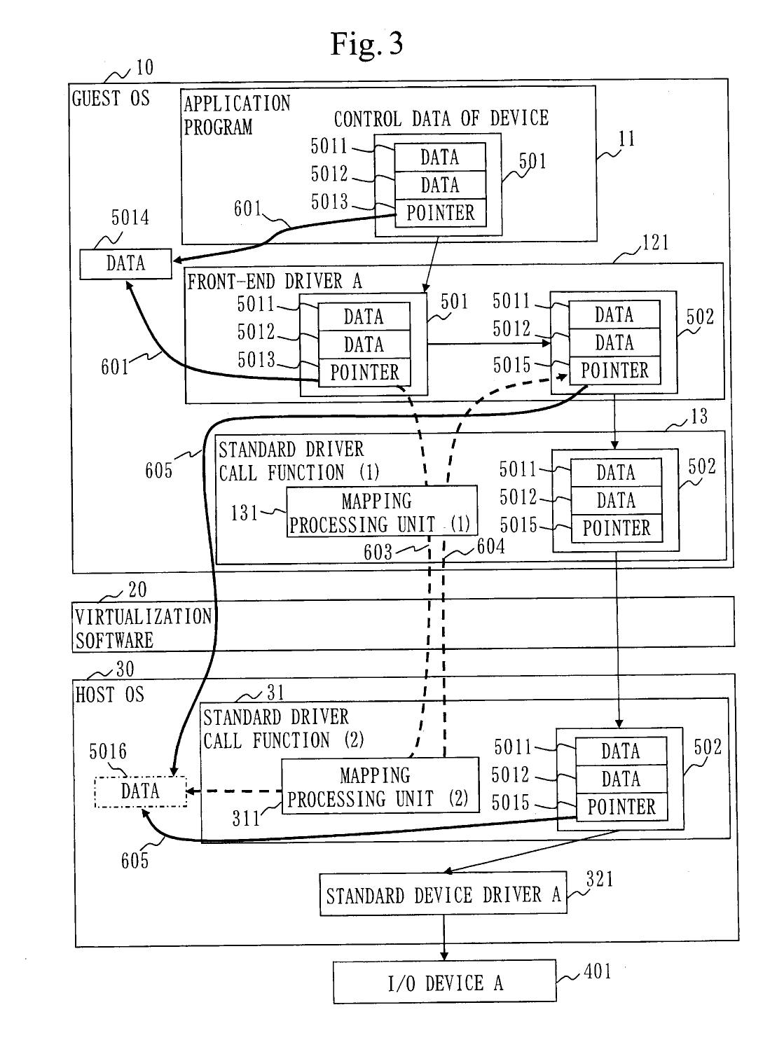

In order to solve the above problem, the present embodiment implements the operation shown in FIG. 3.

In a case where the control data 501 of the I/O device includes the pointer 5013, the front-end driver A 121 passes the pointer 5013 to a mapping processing unit (1) 131 of the standard driver call function (1) 13.

The mapping processing unit (1) 131 maps, via a mapping processing unit (2) 311 of the standard driver call function (2) 31, the data 5014 to any logical address assigned to the host OS 30 (referred to as a “host OS address”, hereinafter) (603).

The front-end driver A 121 obtains, via the mapping processing unit (2) 311 and the mapping processing unit (1) 131, the host OS address which is referable by the host OS 30.

Then, the front-end driver A 121 replaces the pointer 5013 of the control data 501 with a pointer 5015 indicating the obtained host OS address and generates control data 502 (604).

The pointer 5013 is replaced with the pointer 5015, and thereby the host OS 30 is able to recognize the data 5016 is stored in the host OS address (605).

Here, the data 5014 and the data 5016 are held in the same physical address (an address on the RAM 404), and thus they are the same.

The front-end driver A 121 passes the control data 502, via the standard driver call function (1) 13, the virtualization software 20, and the standard driver call function (2) 31, to the standard device driver A 321.

The standard device driver A 321 controls the I/O device A 401 based on the received control data 502.

At this time, since the pointer 5015 of the control data 502 references the host OS address which is referable by the host OS 30, the I/O device A 401 can be controlled correctly.

That is, the standard device driver A 321 reads the data 5016 from the host OS address, thereby controlling the I/O device A 401 based on the read data 5016.

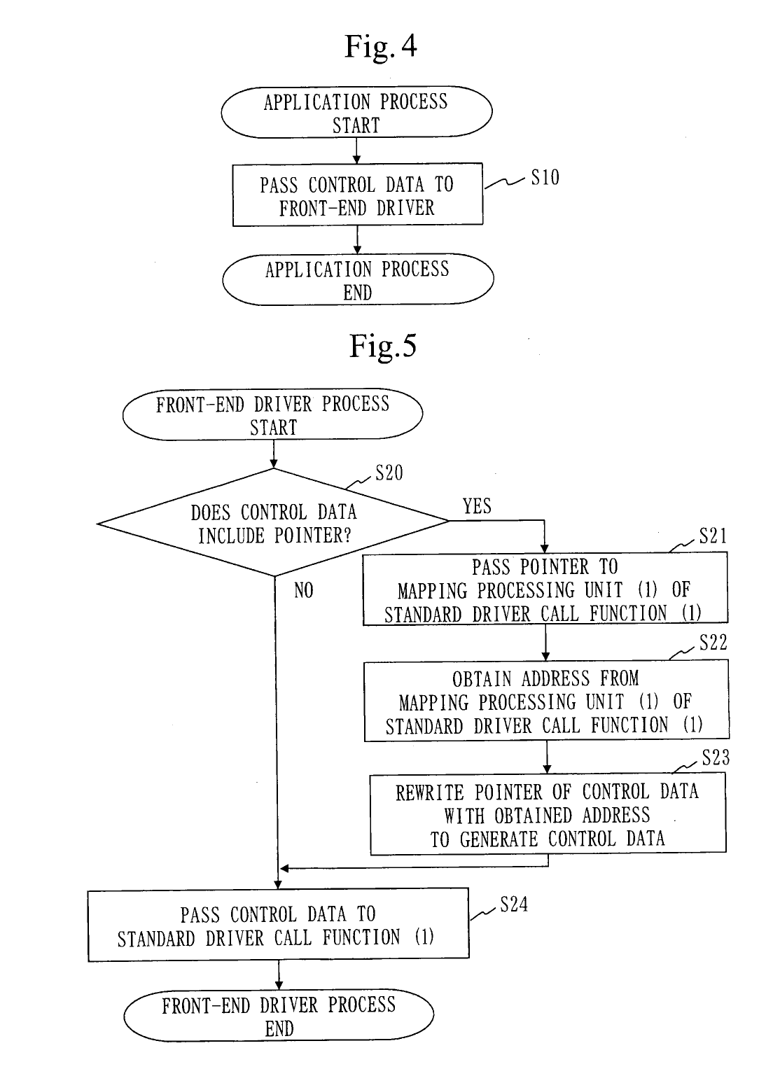

Next, the operation of the virtual computer system 100 according to the present embodiment will be explained with reference to flowcharts of FIGS. 4 to 9.

The application program 11 passes, as shown in FIG. 4, the control data to the front-end driver corresponding to the I/O device which is a target of the control (S10).

Here, in the following, a case will be explained as an example, in which the application program 11 issues the control data for the I/O device A 401 to the front-end driver A 121.

The front-end driver A 121, as shown in FIG. 5, when the control data is received from the application program 11, determines whether or not the control data includes a pointer (S20).

In the pointer, the guest OS address is described as has been discussed above.

If the received control data includes the pointer (YES at S20), the front-end driver A 121 passes the pointer to the mapping processing unit (1) 131 of the standard driver call function (1) 13 (S21).

Then, the front-end driver A 121 obtains the host OS address from the mapping processing unit (1) 131 of the standard driver call function (1) 13 (S22).

Further, the front-end driver A 121 replaces the original pointer inside the control data with a pointer which indicates the obtained host OS address, thereby generating new control data (S23).

Further, the front-end driver A 121 outputs the new control data to the standard driver call function (1) 13 (S24).

On the other hand, if the received control data does not include a pointer (NO at S20), the front-end driver A 121 outputs the received control data to the standard driver call function (1) 13 without any change (S24).

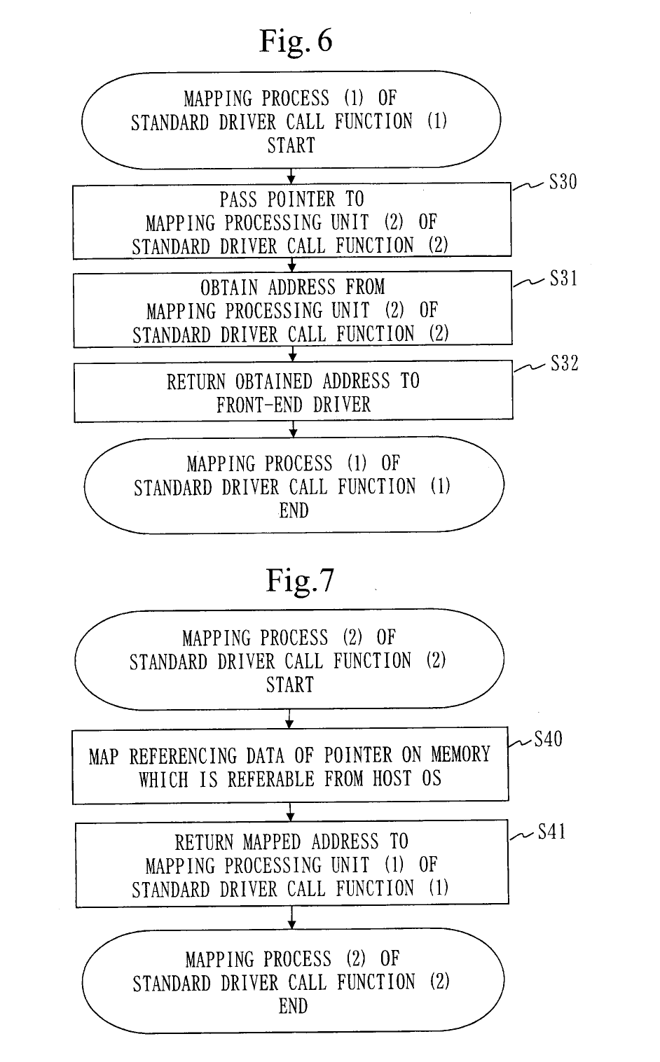

In a case where the pointer output from the front-end driver A 121 is received at S21 of FIG. 5, the mapping processing unit (1) 131 of the standard driver call function (1) 13 outputs the pointer, via the virtualization software 20, to the mapping processing unit (2) 311 of the standard driver call function (2) 31, as shown in FIG. 6 (S30).

Next, the mapping processing unit (1) 131 obtains the host OS address from the mapping processing unit (2) 311 of the standard driver call function (2) 31 (S31), and returns the obtained host OS address to the front-end driver A 121 (S32).

The front-end driver A 121 obtains, as shown in S22 (FIG. 5) of the above description, the host OS address output from the mapping processing unit (1) 131.

In a case where the pointer output from the mapping processing unit (1) 131 is received at S30 in FIG. 6, the mapping processing unit (2) 311 of the standard driver call function (2) 31 maps the data referenced by the pointer to any of the logical addresses referable by the host OS 30, as shown in FIG. 7 (S40).

That is, the mapping processing unit (2) 311 specifies a logical address assigned to the host OS 30 and corresponding to the physical address of the guest OS address described in the pointer, as a host OS address.

Next, the mapping processing unit (2) 311 returns the specified host OS address, via the virtualization software 20, to the mapping processing unit (1) 131 of the standard driver call function (1) 13 (S41).

The mapping processing unit (1) 131 obtains, as shown in S31 (FIG. 6) of the above description, the host OS address output from the mapping processing unit (2) 311.

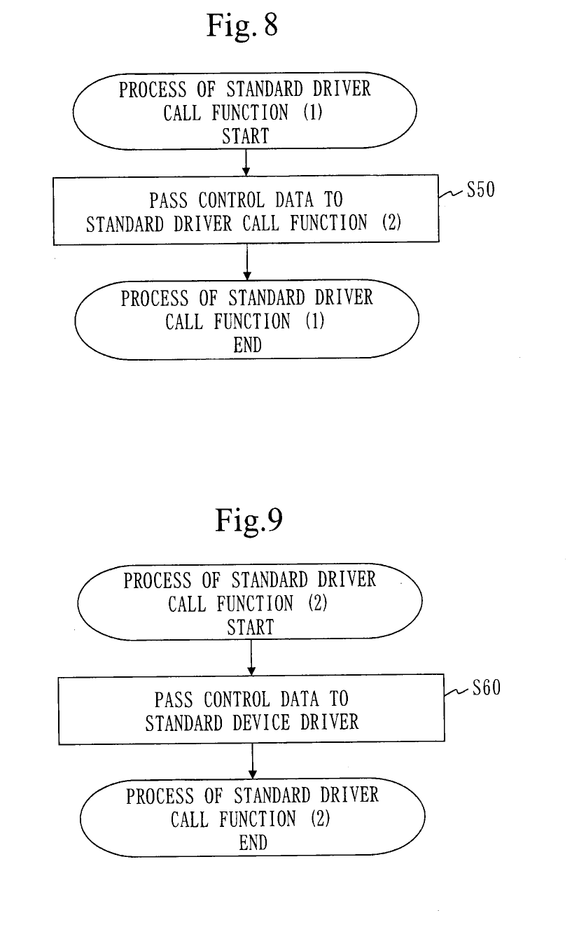

In a case where the control data output from the front-end driver A 121 is received at S24 of FIG. 5, the standard driver call function (1) 13 outputs the control data, via the virtualization software 20, to the standard driver call function (2) 31, as shown in FIG. 8 (S50).

In a case where the control data output from the standard driver call function (1) 13 is received at S50 of FIG. 8, the standard driver call function (2) 31 outputs the control data to the standard device driver A 321 corresponding to the front-end driver A 121, as shown in FIG. 9 (S60).

Thereafter, the standard device driver A 321 controls the I/O device A 401 using the control data.

As discussed above, in the present embodiment, the passing/receiving of the control data to/from the plurality of I/O devices is implemented by, not a unit of a pair of the front-end driver and the back-end driver, but a unit of the standard driver call function (1) 13 and the standard driver call function (2) 31.

Therefore, complex development with considering the internal configuration of the virtualization software for each of the I/O device A 401 and the I/O device B 402 which is a target of the virtualization become unnecessary; only the development of the front-end driver A 121 and the front-end driver B 122 with considering the interface with the standard device driver A 321 and the standard device driver B 322 enables to virtualize the I/O device A 401 and the I/O device B 402.

That is, there is no need to develop the back-end driver.

Further, even at the time of H/W update, since the interface with the standard device driver A 321 and the standard device driver B 322 does not change, re-development is unnecessary for the front-end driver A 121, the front-end driver B 122, and the standard driver call function (1) 13 of the guest OS 10 side.

Therefore, at the time of H/W update, the environment of the guest OS side is unnecessary to change.

Further, as for the standard driver call function (2) 31, re-development is unnecessary unless the specification of the host OS 30 is changed.

Note that, hereinbefore, a replacement example of the logical address of the pointer, that is, an example in which the logical address assigned to the guest OS (the guest OS address) is replaced with the logical address assigned to the host OS (the host OS address), has been explained.

Other than the logical address, in a case where the parameter value assigned to the guest OS (the guest OS parameter value) is described in the control data, and where the host OS cannot reference the guest OS parameter value, the guest OS parameter value in the control data can be replaced with the parameter value assigned to the host OS (the host OS parameter value) by the method explained in the present embodiment.

Finally, an example of the hardware configuration of the virtual computer system 100 shown in the present embodiment will be explained.

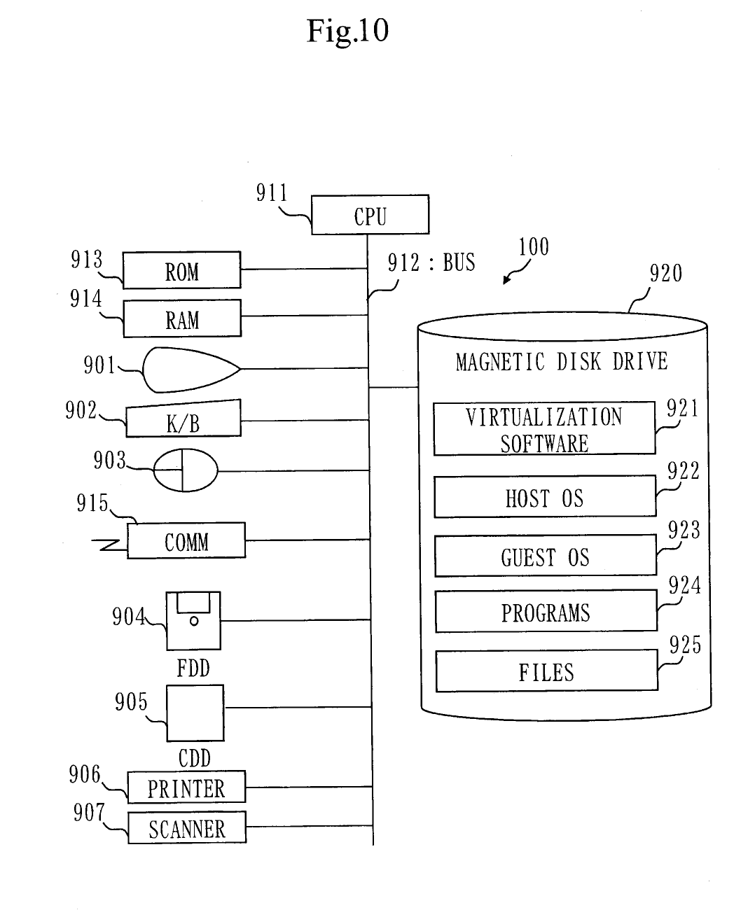

FIG. 10 is a diagram illustrating an example of hardware resource of the virtual computer system 100 of the present embodiment.

Here, the configuration of FIG. 10 merely shows an example of hardware configuration of the virtual computer system 100; and the hardware configuration of the virtual computer system 100 is not limited to the configuration shown in FIG. 10 but can be another configuration.

In FIG. 10, the virtual computer system 100 is provided with a CPU 911 (also referred to as a processor, a central processing unit, a processing device, a calculation device, a microprocessor, a microcomputer) which executes programs.

The CPU 911 corresponds to the CPU 403 of FIG. 1.

The CPU 911 is connected to, via a bus 912, for instance, a ROM (Read Only Memory) 913, a RAM 914, a communication board 915, a display device 901, a keyboard 902, a mouse 903, a magnetic disk drive 920, and a scanner device 907, thereby controlling these hardware devices.

The RAM 914 corresponds to the RAM 404 of FIG. 1.

Further, the communication board 915 and the magnetic disk drive 920 correspond to the I/O device A 401 and the I/O device B 402 of FIG. 1.

Further, the CPU 911 may be connected to a FDD 904 (Flexible Disk Drive), a compact disk drive 905 (CDD), and a printer device 906.

In addition, the magnetic disk drive 920 may be replaced with a SSD (Solid State Drive).

The RAM 914 is an example of a volatile memory.

The storage medium of the ROM 913, the FDD 904, the CDD 905, and the magnetic disk drive 920 are examples of a non-volatile memory.

These are examples of the storage device.

The communication board 915, the keyboard 902, the mouse 903, the FDD 904, the scanner device 907, and the like are examples of the input device.

Further, the communication board 915, the display device 901, the printer device 906, and the like are examples of the output device.

The communication board 915 is connected to a LAN (Local Area Network).

The communication board 915 can be connected to, via the LAN, for instance, the Internet, a WAN (Wide Area Network), and the like.

The magnetic disk drive 920 stores the virtualization software 921, the host OS 922, the guest OS 923, the programs 924, and the files 925.

The virtualization software 921 corresponds to the virtualization software 20 of FIG. 1, the host OS 922 corresponds to the host OS 30 of FIG. 1, and the guest OS 923 corresponds to the guest OS 10 of FIG. 1.

Further, the application program 11 of FIG. 1 is included in the programs 924.

The virtualization software 921, the host OS 922, the guest OS 923, and the programs 924 are executed by the CPU 911.

In this meaning, the CPU 911 (the CPU 403 of FIG. 1) corresponds to a front-end driver processing unit performing the processing of the front-end driver A 121 and the front-end driver B 122, a guest OS side administration processing unit performing the processing of the guest OS side administration unit (the standard driver call function (1) 13), a host OS side administration processing unit performing the processing of the host OS side administration unit (the standard driver call function (2) 31), and a standard device driver processing unit performing the processing of the standard device driver A 321 and the standard device driver B 322.

Further, the files 925 store information, data, signal values, variable values, or parameters illustrating the result of processing that have been explained in the present embodiment as “determination of”, “obtainment of”, “change of”, “replacement of”, “notification of”, “control of”, “specification of”, “receiving of”, “output of”, and the like as “files” or each entry of “database”.

The “files” and “database” are stored in the recording medium such as disks, memories, and the like.

The information, data, signal values, variable values, or parameters stored in the storage medium such as disks, memories, and the like read by the CPU 911 via a read/write circuit to the main memory or the cache memory, and used for the operation of the CPU such as extraction, search, reference, comparison, operation, calculation, processing, edition, output, printing, display, and the like.

During the operation of the CPU of extraction, search, reference, comparison, operation, calculation, processing, edition, output, printing, display, the information, data, signal values, variable values, or parameters is temporarily stored in the main memory, a register, a cache memory, a buffer memory, and the like.

Further, an arrow part of the flowchart used for explaining the present embodiment mainly shows input/output of data or signals; the data or the signal values are recorded in the recording medium such as the memory of the RAM 914, the flexible disk of the FDD 904, the compact disk of the CDD 905, the magnetic disk of the magnetic disk drive 920, other optical disk, a blue-ray (the registered trademark) disk, DVD, and the like. Further, the data or signals are transmitted online through the bus 912, the signal lines, the cable, and other transmission medium.

Further, it is also possible to understand the operation of the virtual computer system 100 explained in the present embodiment as, for example, a data processing method.

In this manner, the virtual computer system 100 shown in the present embodiment is a computer provided with the CPU being the processing unit, the memory, the magnetic disk, and the like being the storage device, the keyboard, the mouse, the communication board, and the like being the input device, the display device, the communication board, and the like being the output device; and the functions shown as the guest OS 10, the virtualization software 20, and the host OS 30 are implemented using the processing unit, the storage device, the input device, and the output device.

### REFERENCE SIGNS LIST

10: guest OS; 11: application program; 13: standard driver call function (1); 20: virtualization software; 30: host OS; 31: standard driver call function (2); 40: hardware; 100: virtual computer system; 121: front-end driver A; 122: front-end driver B; 131: mapping processing unit (1); 311: mapping processing unit (2); 321: standard device driver A; 322: standard device driver B; 401: I/O device A; 402: I/O device B; 403: CPU; and 404: RAM.

1-6. (canceled)

7. A virtual computer system comprising:
hardware including a plurality of physical I/O (Input/Output) devices;
a host OS (Operating System) and a virtual machine monitor that operate on the hardware; and
a guest OS that operates on the virtual machine monitor,
wherein the virtual machine monitor relays data between the guest OS and the host OS,
wherein the guest OS comprises:
a plurality of front-end drivers, each of which corresponds to a physical I/O device of the plurality of physical I/O devices, and receives control data for controlling the corresponding physical I/O device;
wherein the host OS comprises:
a plurality of standard device drivers, each of which corresponds to a physical I/O device of the plurality of physical I/O devices, and controls the corresponding physical I/O device,
wherein each front-end driver
determines whether or not a guest OS parameter value which is a parameter value assigned to the guest OS is described in the received control data,
in a case where the guest OS parameter value is described in the control data, obtains a parameter value assigned to the host OS and corresponding to the guest OS parameter value, via the virtual machine monitor, from the host OS, as a host OS parameter value,
changes a description of the guest OS parameter value to a description of the host OS parameter value in the control data, and outputs the control data in which the host OS parameter value is described, via the virtual machine monitor, to a standard device driver that shares the corresponding physical I/O device, and
wherein each standard device driver
receives the control data in which the host OS parameter value is described in place of the guest OS parameter value, and controls the corresponding physical I/O device based on the received control data.

8. The virtual computer system of claim 7,
wherein the guest OS further comprises:
a guest OS side administration unit that receives the control data from each front-end driver and outputs the received control data to the virtual machine monitor,
wherein the host OS further comprises:
a host OS side administration unit that receives the control data output from the guest OS side administration unit from the virtual machine monitor, and outputs the received control data to the standard device driver related to the front-end driver which is an output source of the received control data,
wherein each front-end driver,
in a case where the guest OS parameter value is described in the control data, obtains the host OS parameter value, via the virtual machine monitor and the guest OS side administration unit, from the host OS side administration unit,
changes a description of the guest OS parameter value to a description of the host OS parameter value in the control data, and outputs the control data in which the host OS parameter value is described, via the guest OS side administration unit, the virtual machine monitor, and the host OS side administration unit, to the standard device driver that shares the corresponding physical I/O device,
wherein each standard device driver
receives the control data in which the host OS parameter value is described in place of the guest OS parameter value from the host OS side administration unit, and controls the corresponding physical I/O device based on the received control data.

9. The virtual computer system of claim 8,
wherein each front-end driver,
in a case where the guest OS parameter value is described in the control data, notifies the host OS side administration unit, of the guest OS parameter value, via the guest OS side administration unit and the virtual machine monitor,
wherein the host OS side administration unit,
in a case where the guest OS parameter value is notified from any one of the front-end drivers, via the guest OS side administration unit and the virtual machine monitor,
notifies the front-end driver which is a notifier of the guest OS parameter value, of the parameter value assigned to the host OS and corresponding to the notified guest OS parameter value, via the virtual machine monitor and the guest OS side administration unit, as the host OS parameter value,
wherein each front-end driver,
in a case where the host OS parameter value is notified from the host OS side administration unit, via the virtual machine monitor and the guest OS side administration unit,
changes a description of the guest OS parameter value to a description of the host OS parameter value in the control data, and outputs the control data in which the host OS parameter value is described to the standard device driver that shares the corresponding physical I/O device, via the guest OS side administration unit, the virtual machine monitor, and the host OS side administration unit.

10. The virtual computer system of claim 8,
wherein each front-end driver
determines whether or not a guest OS address which is a logical address assigned to the guest OS is described in the received control data, as the guest OS parameter value,
in a case where the guest OS address is described in the control data, obtains a logical address assigned to the host OS and corresponding to a physical address of the guest OS address, via the virtual machine monitor and the guest OS side administration unit, from the host OS side administration unit, as a host OS address,
changes a description of the guest OS address to a description of the host OS address in the control data, and outputs the control data in which the host OS address is described to the standard device driver that shares the corresponding physical I/O device, via the guest OS side administration unit, the virtual machine monitor, and the host OS side administration unit,
wherein each standard device driver
receives the control data in which the host OS address is described in place of the guest OS address from the host OS side administration unit, and controls a corresponding physical I/O device based on the received control data.

11. The virtual computer system of claim 10,
wherein each front-end driver,
in a case where the guest OS address is described in the control data, notifies the host OS side administration unit, of the guest OS address, via the guest OS side administration unit and the virtual machine monitor,
wherein the host OS side administration unit,
in a case where the guest OS address is notified from any one of the front-end drivers, via the guest OS side administration unit and the virtual machine monitor, notifies the front-end driver which is a notifier of the guest OS address, of a logical address assigned to the host OS and corresponding to the physical address of the guest OS address, via the virtual machine monitor and the guest OS side administration unit, as the host OS address,
wherein each front-end driver,
in a case where the host OS address is notified from the host OS side administration unit, via the virtual machine monitor and the guest OS side administration unit,
changes a description of the guest OS address to a description of the host OS address in the control data, and outputs the control data in which the host OS address is described to the standard device driver that shares the corresponding physical I/O device, via the guest OS side administration unit, the virtual machine monitor, and the host OS side administration unit.

12. The virtual computer system of claim 8,
wherein the hardware includes:
a physical processor,
wherein the physical processor comprises:
a front-end driver processing unit that performs a process of each front-end driver;
a guest OS side administration processing unit that performs a process of the guest OS side administration unit;
a host OS side administration processing unit that performs a process of the host OS side administration unit; and
a standard device driver processing unit that performs a process of each standard device driver.
